(19) United States
(12) Patent Application Publication
(10) Pub. No.: US 2013/0077892 A1
(43) Pub. Date: Mar. 28, 2013

(54) Scan Order Optimization and Virtual Slide Stitching

(71) Applicants: Yasunori Ikeno, Santa Clara, CA (US); Marty Moran, Yokneam (IL)

(72) Inventors: Yasunori Ikeno, Santa Clara, CA (US); Marty Moran, Yokneam (IL)

(21) Appl. No.: 13/475,257

(22) Filed: May 18, 2012

Related U.S. Application Data
(60) Provisional application No. 61/539,903, filed on Sep. 27, 2011.

(51) Int. Cl. G06K 9/36

(52) U.S. Cl. 382/286; 382/276

(57) ABSTRACT

Virtual microscopy and other system may benefit from a system that can build the large mosaic by stitching images, and overcoming positioning error of stages used to provide the images. In particular, these systems may benefit from scan order optimization and virtual slide stitching techniques. A method can include analyzing, by a machine, a low resolution image of a sample. The method can also include determining, by the machine, a scan pattern for the sample based on analysis of the low resolution image of the sample. The method can further include controlling, by the machine, the scan based on the scan pattern, wherein the scan pattern is configured to minimize an amount of back-stitching of scans in the scan pattern.

### CROSS REFERENCE TO RELATED APPLICATIONS

This application is related to, claims the priority of, and incorporates by reference herein the entirety of U.S. Provisional Patent No. 61/539,903, filed Sep. 27, 2011.

### BACKGROUND

1. Field

Virtual microscopy and other system may benefit from a system that can build the large mosaic by stitching images, and overcoming positioning error of stages used to provide the images. In particular, these systems may benefit from scan order optimization and virtual slide stitching techniques.

2. Description of the Related Art

Virtual microscopy is a method that is used to provide a digital representation of an entire slide, although when inspecting samples, such as biological samples, with optical microscope, only small part of a sample is typically visualized at a time. To generate a virtual slide out of the sample on a glass slide, an automatic microscope system can scan the entire slide and capture images from all sites, and compose these images into a large mosaic.

To obtain a digital image of a large sample under a microscope, where the sample is much larger than the FOV of the microscope, multiple images can be taken and then combined to form a single sample image. To combine the single FOV images, there is typically some overlap so that portions of the images can be matched and aligned for the combination process. Since the samples may be of random shape and size, it can occur during the scanning process that a single image may not have a portion of the sample (image data or pixels with sample information) in the overlap area for the matching and aligning (stitching) process. In order to accomplish correct stitching the system can put all incoming images into a temporary container and continue the stitching when the appropriate images will arrive. Such an approach can significantly slow down the throughput.

A virtual slide system may impose requirements such as to scan and generate output data for a sample area of 2.25 square centimeters in 20× magnification in one minute. As the field of view (FOV) is 750×750 micron and typical overlap is 10% of the net size of each image, the unique portion of the image may be 675×675 micron. Thus, 490 sites may be used to cover the whole sample. Each site image may be approximately 12 Mb. Consequently, when scanning a full slide, 50 mm×25 mm, in high magnification the number of sites can be greater than 10000 sites per scan.

### SUMMARY

According to certain embodiments, a method includes analyzing, by a machine, a low resolution image of a sample. The method also includes determining, by the machine, a scan pattern for the sample based on analysis of the low resolution image of the sample. The method further includes controlling, by the machine, the scan based on the scan pattern, wherein the scan pattern is configured to minimize an amount of back-stitching of scans in the scan pattern.

A method, in certain embodiments, includes generating, by a machine, strips corresponding to edges of an image to be stitched with another image to form a composite image. The method also includes storing the strips in a strip repository. The method further includes moving, by the machine, the image to a full image repository. The method additionally includes processing tiles from a tiles repository, wherein the tiles include at least one tile obtained from the image.

An apparatus, according to certain embodiments, includes a low resolution analysis section configured to analyze a low resolution image of a sample. The apparatus also includes a scan pattern determination section configured to determine a scan pattern for the sample based on analysis of the low resolution image of the sample. The apparatus further includes a controller configured to control the scan based on the scan pattern, wherein the scan pattern is configured to minimize an amount of back-stitching of scans in the scan pattern.

In certain embodiments, an apparatus includes a strip generator configured to generate strips corresponding to edges of an image to be stitched with another image to form a composite image. The apparatus also includes a memory manager configured to store the strips in a strip repository and to move the image to a full image repository. The apparatus further includes a processor configured to process tiles from a tiles repository, wherein the tiles include at least one tile obtained from the image.

### BRIEF DESCRIPTION OF THE DRAWINGS

For proper understanding of the invention, reference should be made to the accompanying drawings, wherein:

FIG. 1 illustrates a discontinuous scanning pattern.

FIG. 2 illustrates a less discontinuous scanning pattern with respect to back-stitching according to certain embodiments.

FIG. 3 illustrates a slide including an area of a global slide image (GIS) that can be used for obtaining stitching information according to certain embodiments.

FIG. 4 illustrates a method according to certain embodiments.

FIG. 5 illustrates X and Y overlaps according to certain embodiments.

FIG. 6 illustrates a shift determination according to certain embodiments.

FIG. 7 illustrates stitching outcomes according to certain embodiments.

FIG. 8 illustrates a process flow according to certain embodiments.

FIG. 9 illustrates another process flow according to certain embodiments.

FIG. 10 illustrates a pyramidal structure of an image according to certain embodiments.

FIG. 11 illustrates an iterative process according to certain embodiments.

FIG. 12 illustrates a method according to certain embodiments.

FIG. 13 illustrates an imaging system according to certain embodiments.

FIG. 14 illustrates an imaging system according to certain embodiments.

FIG. 15 illustrates another imaging system according to certain embodiments.

### DETAILED DESCRIPTION

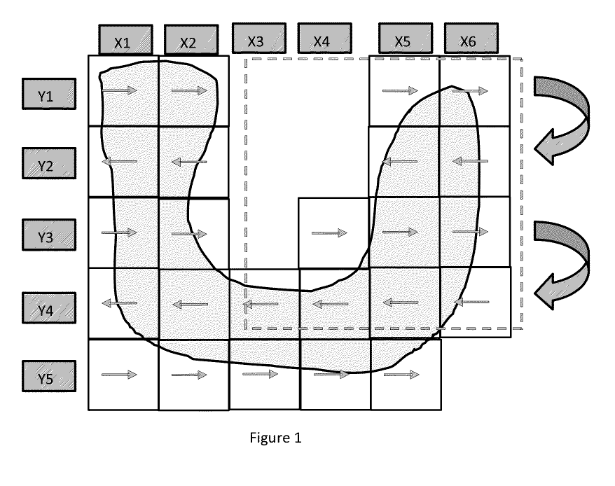

FIG. 1 illustrates a discontinuous scanning pattern. In the example shown, the scanning starts with site (X1,Y1) then (X2,Y1) (X5,Y1) (X6,Y1), and so on. As there is no continuation between (X2,Y1) and (X5,Y1) and more, all the sites in the broken-line rectangle cannot be processed immediately according to traditional techniques. Instead, the images conventionally must be stored until further appropriate (border) images are acquired to continue the stitching process.

More generally, the scan order can be affected by two major factors. A first factor is the structure of the sample on the slide. A sample can have any shape. An area without a sample present can be ignored to improve throughput and to reduce the volume of the data.

A second factor is the scanning hardware, namely the XY stage. The term XY stage refers to a stage that can move in an X direction and a Y direction. There is no limitation on the stage moving in other directions, such as in the Z direction. Due to some hardware limitations, for example, hysteresis, meshing losses and the like, it may be desired to move in one direction rather than change direction for each site or field of view (FOV). In other words, it may be desired to minimize the reversals in direction.

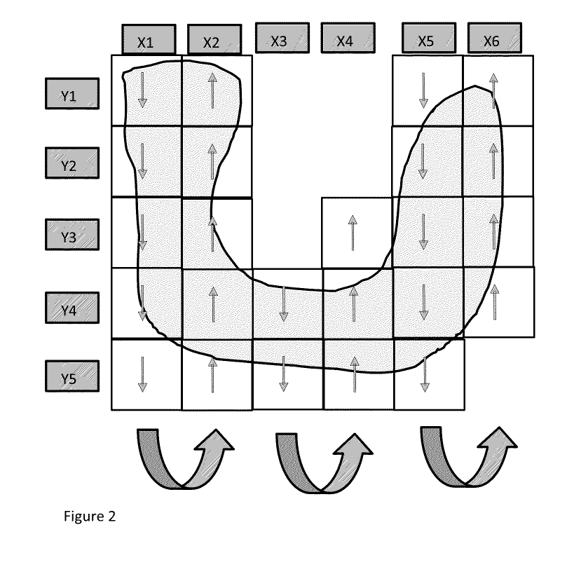

Certain embodiments use a priori information about the sites' location in the slide to define the scan order in such a way to minimize the number of sites that cannot be processed immediately after capture. FIG. 2 illustrates a less discontinuous scanning pattern with respect to back-stitching according to certain embodiments. For example, the only case in which a field of view cannot be attached to the immediately preceding field of view is at the transition from X4 to X3, but even there the field of view can be immediately stitched to (X4,Y4). By contrast, in FIG. 1, all the fields of view shown in the dashed box can be held in a buffer until (X2,Y4) is scanned. Therefore, FIG. 1 is more discontinuous with respect to back-stitching and can impose a greater burden on system resources than the approach shown in FIG. 2.

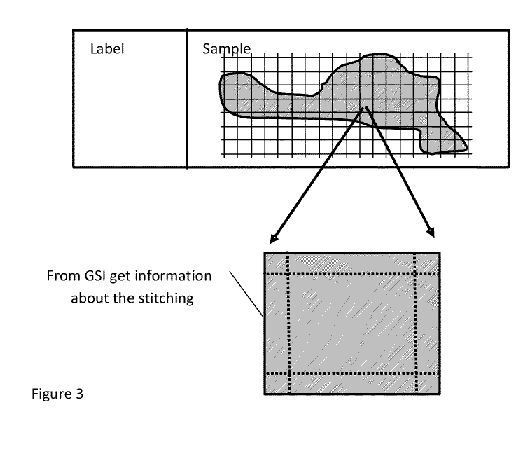

FIG. 3 illustrates a slide including an area of a global slide image (GIS) that can be used for obtaining stitching information according to certain embodiments. Using a lower magnification and lower resolution image or images, additional information can be gathered about each site position, as shown in FIG. 3. A stitching quality attribute can be achieved by evaluating the data near the border of each site inside the lower magnification image. Based on this attribute, a scan order is deduced that will improve scanning and stitching speed. Thus, using GSI data can improve the information per site.

In certain embodiments, the goal of scanning may be defined by getting the best throughput and using minimum computing resources. Thus, the stitching quality attributes may be related to these definitions. For example, the goal can be to find the scanning route that generates minimal discontinuity in the stitching data, or that generates minimal discontinuity in the stitching data, given a selection of scanning patterns that minimize direction changes.

The system can employ various techniques for determining which scanning procedure is best. For example, the system can determine two optional scanning patterns based on two patterns that minimize the number of changes in direction. In one case, the system can determine the two possible scanning patterns shown in FIGS. 1 and 2. The system can then determine, based on the stitching data, that the approach of FIG. 1 will require more buffer resources than the approach in FIG. 2, and can consequently select the approach in FIG. 2. The system can alternatively make similar calculations for all possible scanning patterns and select a pattern that minimizes buffer resources, or that provides the best trade-off between consumption of buffer resources and direction changes. Thus, by trial run of the optional routes, the system can find the route that has minimal discontinuity. Other techniques for finding the optimal route are also permitted. For example, a solution similar to a solution for a travelling purchaser problem may be employed for minimizing the buffer resource requirements while taking into account the effect on direction changes.

Accordingly, certain embodiments can use a priori information about the site locations to plan the scan order. Moreover, certain embodiments can use information from the low resolution image or GSI image to identify additional attributes about each site or field of view. Moreover, certain embodiments can rearrange a traditional scan order so as to minimize the number of sites that cannot be processed immediately. Accordingly, certain embodiments can provide a flexible scanning engine to support all types of site order combinations. Moreover, certain embodiments can use information from a low resolution image or GSI image to decide whether a site is stitchable and for which direction(s).

As described above, the amount of memory used for storing the images may be substantial, depending on the size of the images and the number of images to be stitched together. To avoid or minimize such requirements for large memory and high throughput, a system can implement a sequence of operations that process the sites' data as soon as possible, to prevent data accumulation and delay in process.

For example, the memory can be handled by a memory manager that optimizes the memory for minimal usage. Moreover, throughput can be handled by implementing multithreaded architecture taking advantage of the multicore processor's parallel computing power.

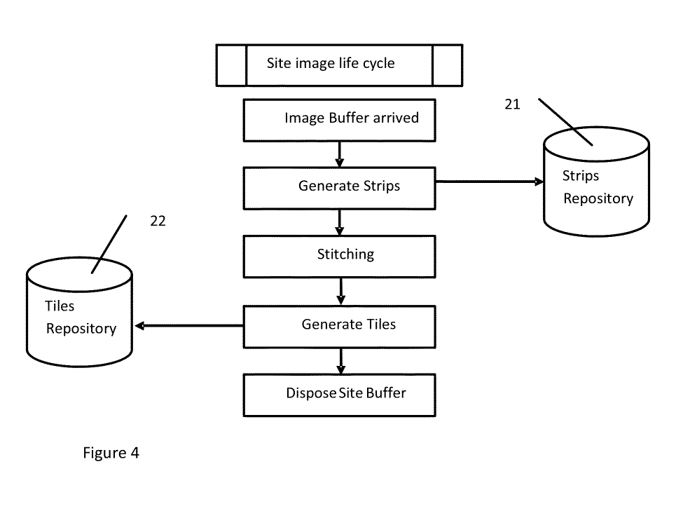

FIG. 4 illustrates a method according to certain embodiments. As shown in FIG. 4, the processing of an image start immediately as it becomes available. To minimize memory usage, the system can copy data from the raw image into the strips repository 21 for stitching. After the image stitch, the tiles including partial tiles can be copied into the tiles repository 22. As the copy operation is completed the input image buffer is purged.

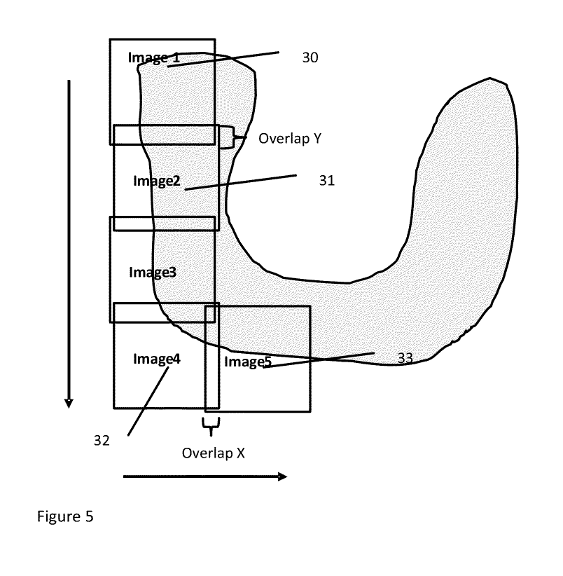

FIG. 5 illustrates X and Y overlaps according to certain embodiments. As shown in FIG. 5, to cover the sample area, the system motorized stage can move from site to site based on a pre-defined scanning plan, which can be optimized as discussed above. Each site can have some overlap with its predecessor site. The overlap can be in X or Y based on the scanning direction. In FIG. 5, in a particular example, the first site to be captured can be image 1 (30). The second site can be image 2 (31), which overlaps in the Y direction with image 1 (30), as the scanning movement direction is in the Y direction. Image 5 (33) can arrive after image 4 (32). In this case, the overlap is in the X direction, as the stage has moved in the X direction.

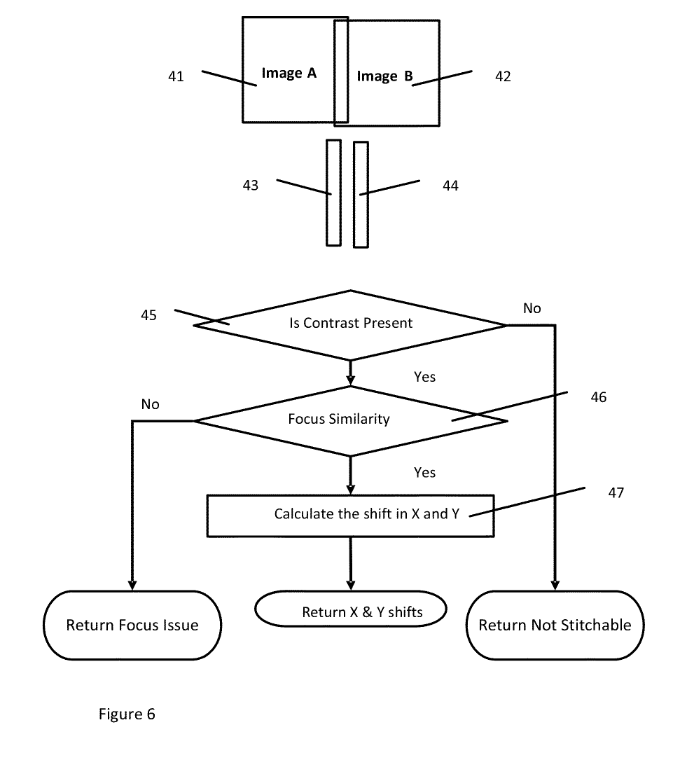

FIG. 6 illustrates a shift determination according to certain embodiments. A stitch operation can be started by making alignment between the sites. The alignment may be required in order to generate a good mosaic from the sample slide. To measure the shift between two images, the shared area between these two images, namely the strips, can be employed. In FIG. 6, image A (41) and image B (42) can be considered. To find out the amount of misalignment between them the system can take Strip A (43) and Strip B (44), respectively from image A (41) and image B (42).

Then, at 45, there can be a verification as to whether there is contrast present. If contrast is ok, then at 46 the system can verify focus similarity. If both of these validation tests are passed, then a correlation operator can, at 47, calculate/measure the alignment in the X and Y directions, and return X and Y shifts. If the focus check fails, the system can return that there is a focus issue, which can lead, for example, to a re-imaging of the site or an attempt to proceed as though the tiles are not stitchable. If no or insufficient contrast is present, the system can return a “not stitchable” result.

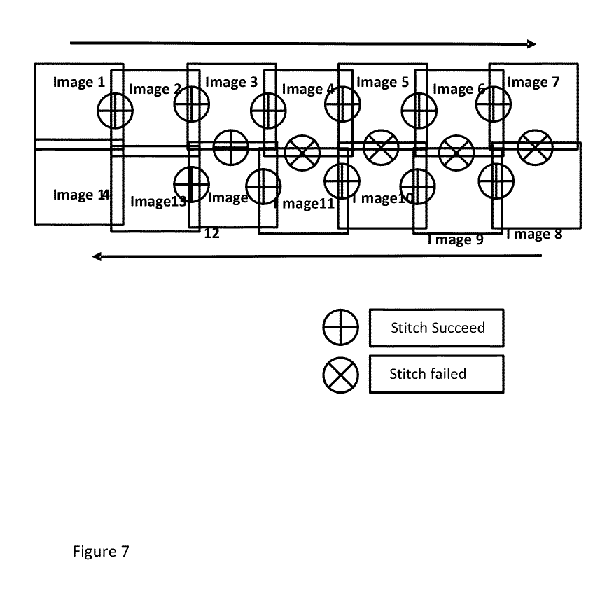

FIG. 7 illustrates stitching outcomes according to certain embodiments. As shown in FIG. 7, during the scanning and stitching operation there can arise situations in which images cannot be stitched immediately or at all due to lack of sample information in the share area. In such cases, the system can tag the image as “Not Ready” and can continue to the next image. When the system has found that the stitching conditions are met it, it can go back and stitch all the “Not Ready” images.

In FIG. 7, image 2 stitches to image 1, image 3 stitches to image 2 and so on until image 7 stitches to image 6. Image 8 is supposed to, or expected to stitch to image 7, but this failed. The system can tag image 8 as “Not Ready” and can continue by attempting to stitch image 9 to image 8, which is a success, but when attempting to stitch image 9 to image 6, the stich Failed, and so image 9 is tagged as “Not Ready”. Then, the system can stitch image 10 to image 9 successfully, but then fail to stitch image 10 to image 5, and consequently image 10 can be tagged as “Not Ready”. Likewise, the attempt to stitch image 11 to image 10 can be a success, but the attempt to stich image 11 to image 4 can fail and the system can tag image 11 as “Not Ready”. Then, the system can stitch image 12 to image 11 successfully and stitch image 12 to image 3 successfully. At this point the system can start the backward stitching by correcting the stitching values of image 11 and tagging it as “Ready,” correcting the stitching values of image 10 and tagging it as “Ready,” correct the stitching values of image 9 and tagging it as “Ready,” and finally correcting the stitching values of image 8 and tagging it as “Ready.”

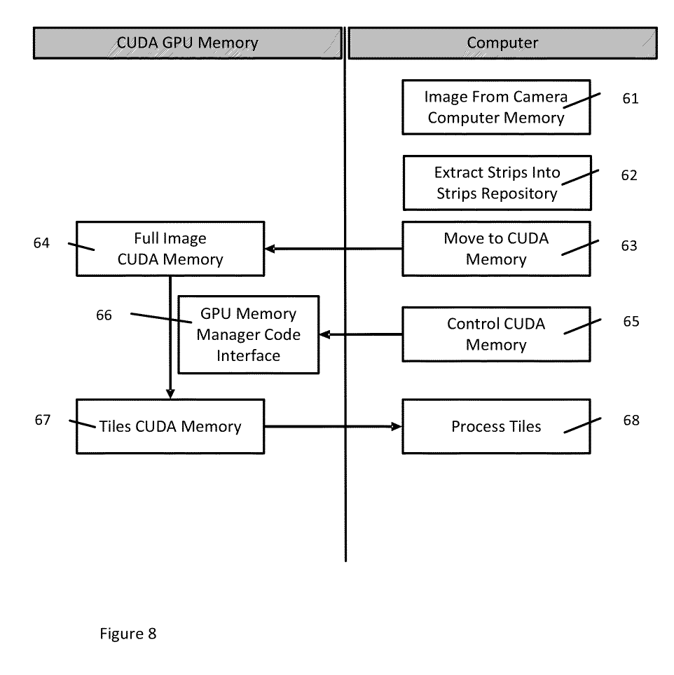

FIG. 8 illustrates a process flow according to certain embodiments. As mentioned above, a memory manager can be designed to handle a memory repository for original images coming from the camera and the tiles that are used to generate the output for the mosaic. To enlarge the amount of available memory, one option is to use an onboard memory on the CUDA GPU card. This card may have, for example, 3.5 GB of free memory available for the memory manager. If CUDA memory is not used, a computer memory repository can be used or both can be used together.

As shown in FIG. 8, if CUDA memory is used, the image from the microscope camera can arrive in the computer memory at 61. Next, the system can extract the strip buffers from the image into the Strips Repository at 62. Then, at 63, the system can move the image buffer to the CUDA memory, where it is received at 64, and can dispose or purge it from the computer memory.

As the application stitches an image it can also instruct, at 65, the CUDA GPU to generate the tiles form this image by using the GPU memory manager code interface, at 66.

A get method in the GPU memory manager can transfer, at 67, the tile buffer to the computer memory when the application needs to have access to a tile, such as for processing the tile at 68.

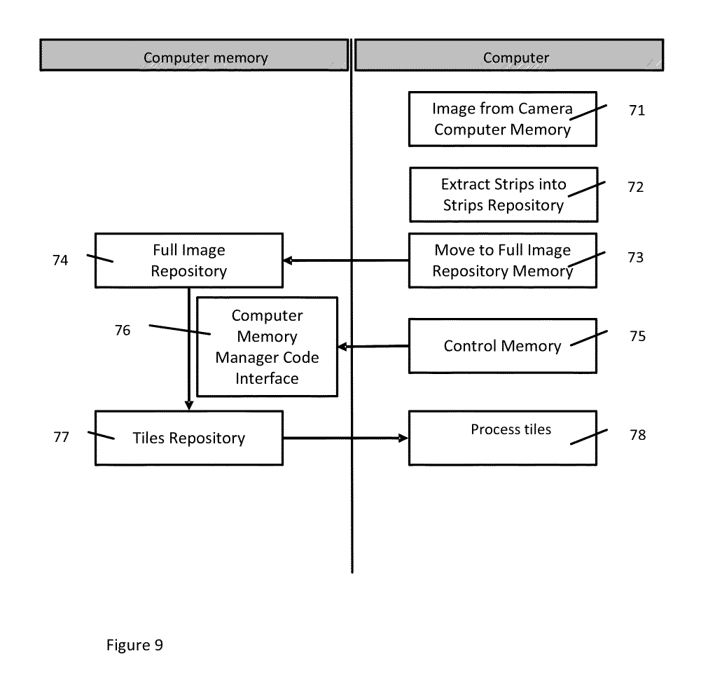

FIG. 9 illustrates another process flow according to certain embodiments. FIG. 9 illustrates a case in which CUDA memory is not used. As shown in FIG. 9, the image from the microscope camera can arrive in the computer memory at 71. Next, the computer can, at 72, extract the strip buffers from the image into the Strips Repository. Then, the computer can, at 73, move the image buffer and it can be received at 74 in the full image memory repository.

As the application stitches an image, it can also generate tiles from this image, through control, at 75, by using the memory manager code interface at 76. Moreover, a get method in the memory manager at can copy the tile buffer at 77 when the application needs to have access to a tile, such as to process a tile at 78.

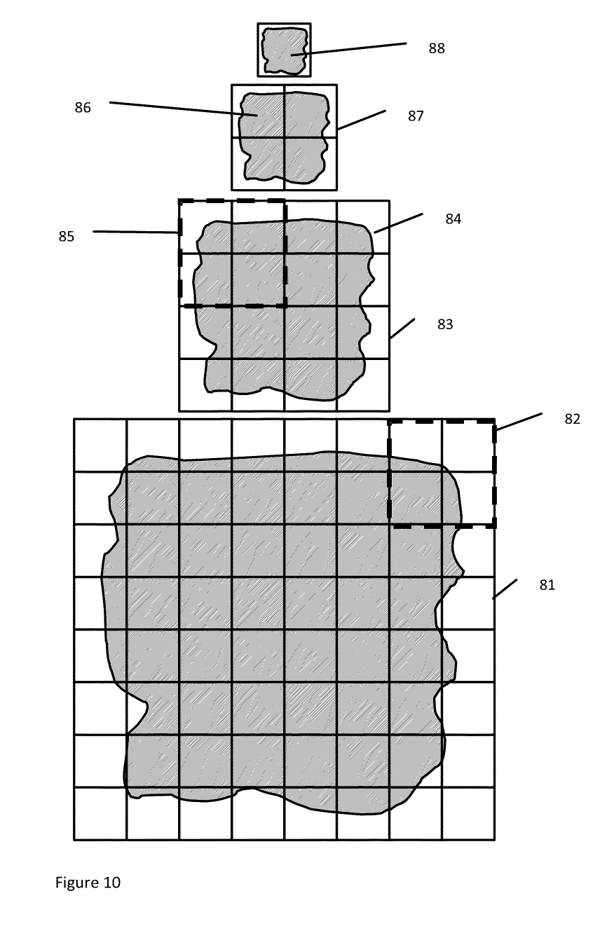

FIG. 10 illustrates a pyramidal structure of an image according to certain embodiments. As shown in FIG. 10, the scanning result can be a multi-resolution image stored in a pyramidal format. In this format, the high resolution image 81 can be subdivided into spatial tiles that can be used for generating the whole image at different resolutions.

In the pyramidal format, each level in the pyramid can be constructed from the predecessor level, while the successor level can use the current level. In other words, each level can be constructed from the level preceding it.

For example, for the intermediate level 83 a tile 84 is composed from the four tiles 82 in its predecessor level. In the intermediate level 87, a tile 86 is composed from the four tiles 85 in the layer below it. The last level can be a single tile 88, which can also serve as a thumbnail.

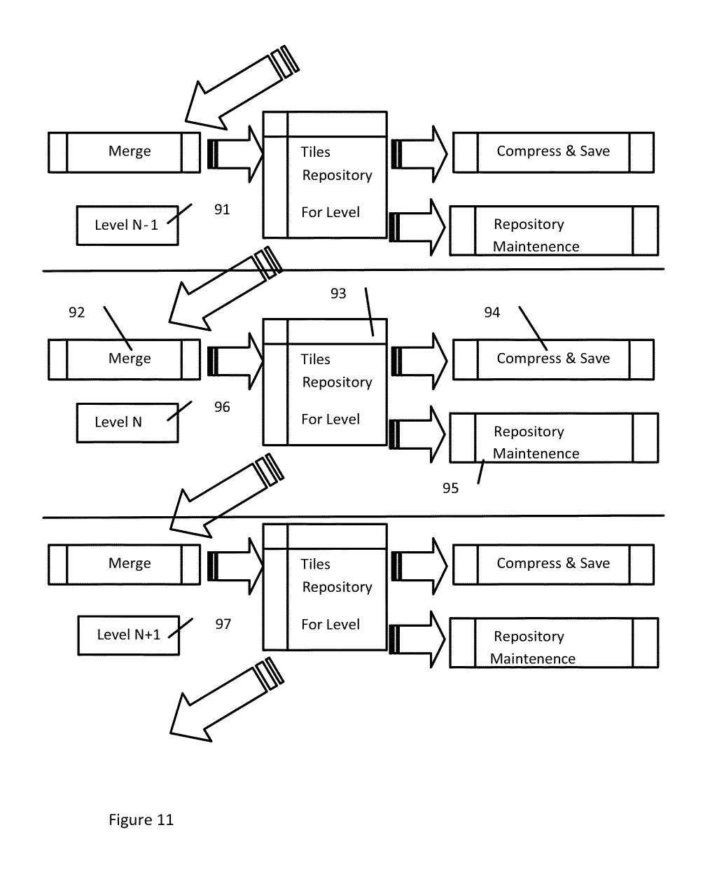

FIG. 11 illustrates an iterative process according to certain embodiments. As shown in FIG. 11, for each of the levels there can be three major threads that handle the data. For a given level 96, the “Merge” thread 92 can be responsible for collecting the appropriate tiles from the “Tiles Repository for Level” in the predecessor level 91. Each of the combined tiles can be added to the “Tiles Repository for Level” 93. The “Compress & Save” thread 94 can be taking in the ready tiles, compressing them, and then saving them to the disk. The compression method can be defined in the graphical user interface of the application. The “Repository Maintenance” thread 95 can be responsible to manage the “Tiles Repository for Level” 93 and to delete each of the tiles that has been saved to disk and also has been consumed by the successor level.

Accordingly, certain embodiments use a repository/queue and multi-threads for high throughput. Moreover, certain embodiments do not keep entire the whole slide image, for example high resolution image, in memory. Instead, in certain embodiments, it can be removed from memory as soon as shift is calculated. A backward stitching feature can be used to help making a stitching result reliable at an area of less sample availability.

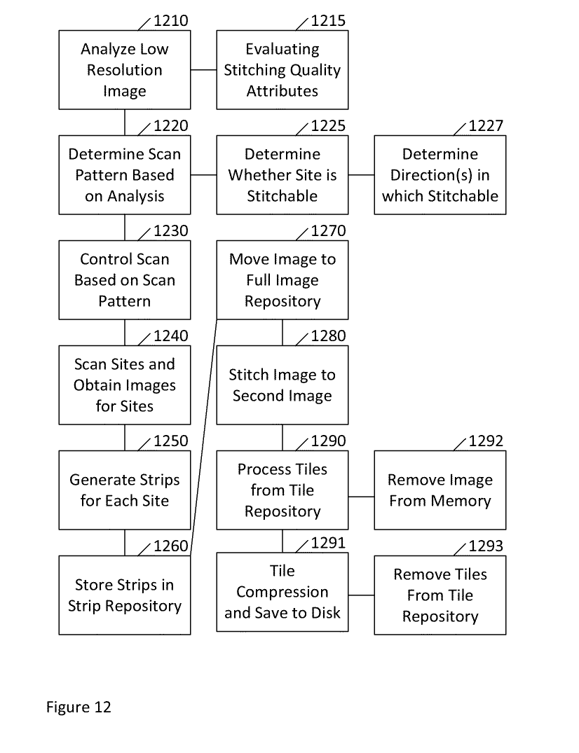

FIG. 12 illustrates a method according to certain embodiments. As shown in FIG. 12, a method can include at 1210, analyzing, by a machine, a low resolution image of a sample. The low resolution image of a sample can include a low resolution image of an entire slide. The analyzing can include, at 1215, evaluating a stitching quality attribute by evaluating data near the border of a plurality of sites inside the low resolution image.

The method can also include, at 1220, determining, by the machine, a scan pattern for the sample based on analysis of the low resolution image of the sample. The determining the scan pattern can be based on the stitching quality attribute for each of the sites. The method can, at 1225, include determining, for each of the plurality of sites, whether a site is stitchable. The method can also, at 1227, include determining, for each of the plurality of sites, a set of at least one direction in which a site is stitchable. For example, a given site that is rectangular may be stitchable in up to four directions, based on the contents of its strips.

The method can further include, at 1230, controlling, by the machine, the scan based on the scan pattern, wherein the scan pattern is configured to minimize an amount of back-stitching of scans in the scan pattern.

Meanwhile, the method can also include, at 1240, scanning the sites and obtaining the images that correspond to the sites. The method can further include, at 1250, generating, by a machine, strips corresponding to edges of an image to be stitched with another image to form a composite image. The method can additionally include, at 1260, storing the strips in a strip repository. The strip repository can be referenced when making determinations about whether stitching is in practice possible for a pair of images.

The method can also include, at 1270, moving, by the machine, the image to a full image repository. The full image repository can store the image in the computer memory or GPU memory or in a large volume disk, such as a hard disk drive. The method can further include, at 1290, processing tiles from a tiles repository, wherein the tiles include at least one tile obtained from the image. The method can additionally include, at 1291, tile compression and saving the tiles to disk. After that, the method can include removing tiles from the tile repository, at 1293.

The method can also include, at 1292, removing, by the machine, the image from the memory before a whole slide of which the image is a part has been processed. The method can include, for example, moving the image from a computer memory to a memory of a graphics processing unit after extracting the strips.

The method can further include, at 1280, stitching the image to another image and, at 1292, removing the image from a buffer after the stitching. In this case, the stitching can be simply a determination and recording of the appropriate shifts for stitching It is not required that the files themselves be combined.

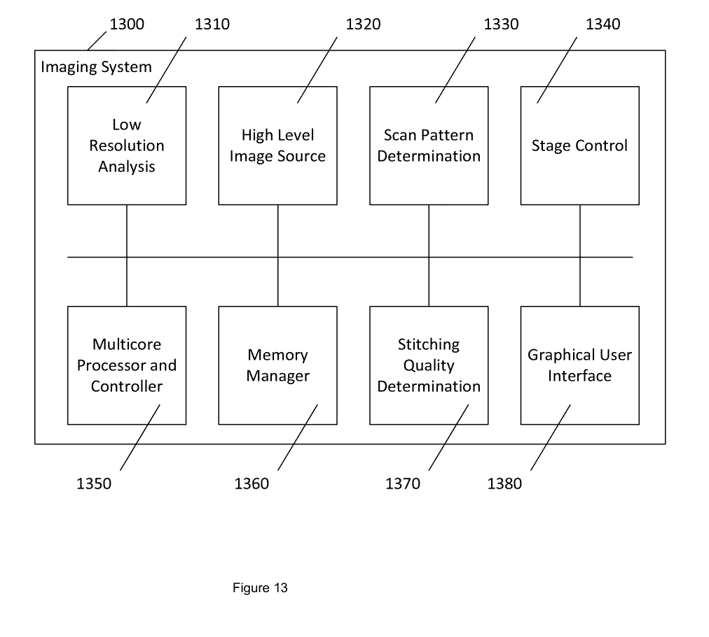

FIG. 13 illustrates an imaging system according to certain embodiments. As shown in FIG. 13, an imaging system 1300 can include a low resolution analysis section 1310, which can determine the characteristics of the sample to be scanned as well as characteristics of the tiles to be generated from such a scan. The system 1300 can also include a high level image source 1320, which can be either a camera for capturing a high level, low resolution macro image, or can be a memory in which the images from such a camera are stored. The system 1300 can also include a scan pattern determination section 1330. This section can determine the appropriate pattern of a scanner with respect to a slide in time. For example, this section can determine an optimal slide pattern that minimizes back-stitching.

The system 1300 can include a stage control 1340, which can be configured to control the stage used for imaging. The system 1300 can also include a multicore processor and controller 1350, which can be configured to perform multiple processing tasks in parallel. The imaging system 1300 can also include a memory manager 1360. The memory manager 1360 can be configured to control which images, tiles, and strips are stored, and in which memory such images, tiles, and strips are stored, as well as when such images, tiles, and strips are removed from the memory.

The system 1300 can also include a stitching quality determination section 1370. This section can determine the stitching attributes of a tile, and can more particularly determine whether a particular stitching is successful or not. The stitching quality determination section 1370 can interface with the memory manager 1360 to determine whether an image should be retained because it has not yet been fully stitched as illustrated in FIG. 7 above. The system can further include a graphical user interface 1380, which can permit user input, retrieval, supervision, and control, as desired.

The various sections of the imaging system 1300 are shown connected by a physical bus. Other kinds of interconnections are also permitted. It is permitted to divide up the imaging system 1300 into multiple physical sections that are separate from one another, although the various components are shown together. The various sections can be implemented in hardware or in software and hardware combined.

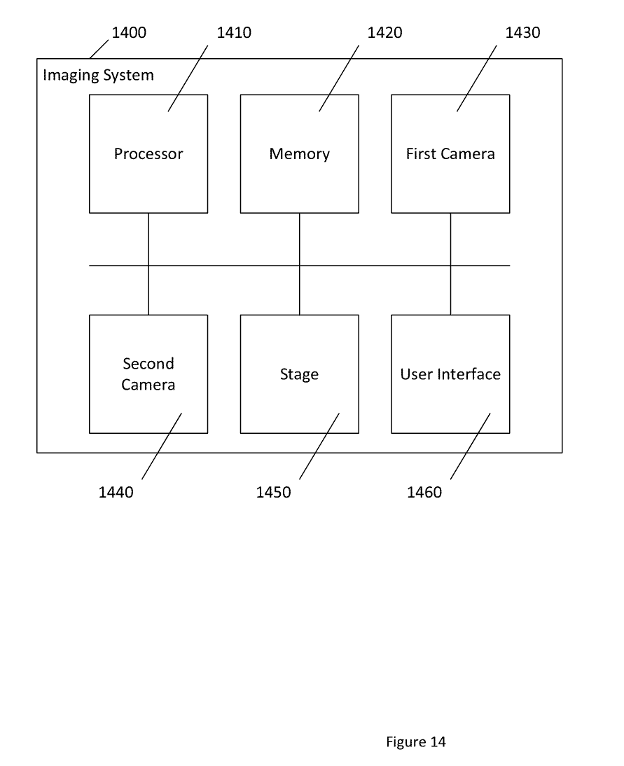

FIG. 14 illustrates an imaging system according to certain embodiments. As shown in FIG. 14, an imaging system 1400 can include at least one processor 1410 and memory 1420, which can include computer program instructions. The memory 1420 can be a non-transitory computer-readable medium. The imaging system 1400 can also include a first camera 1430, which may be a low resolution camera, and a second camera 1440, which may be a high resolution camera.

The imaging system 1400 can also include a stage 1450 or other device by which the camera position can be controlled. The imaging system 1400 can additionally include a user interface 1460, which can be used to input values and configure parameters of the system.

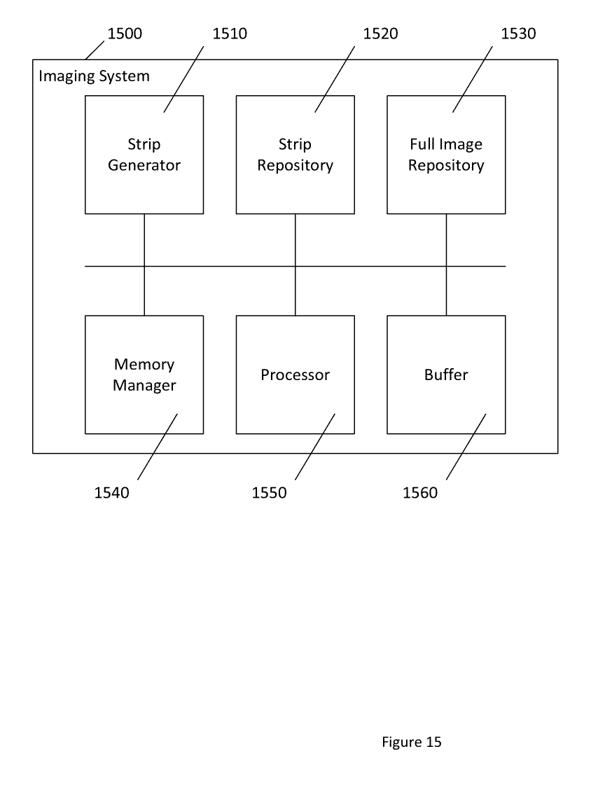

FIG. 15 illustrates another imaging system according to certain embodiments. As shown in FIG. 15, an imaging system 1500 can include at least one strip generator 1510 and strip repository 1520, which can include respectively generate and store strips for an image. The imaging system 1500 can also include a full image repository 1530, which can be configured to store full images. The imaging system 1500 can also be equipped with a memory manager 1540, which can be responsible for the movement, purging, disposal, and copying of information.

The imaging system 1500 can further include a processor 1550 or other controller that can be used to perform processing on images, tiles, strips, and the like. The imaging system 1500 can additionally include a buffer 1560, which can be used for temporary storage of information, with a relative high speed compared to the strip repository 1520 or full image repository 1530.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY OF ABBREVIATIONS/TERMS

AFA Active Focus Area

Active Focus Area can refer to the area within a camera FOV where the autofocus hardware will evaluate the image information for focus measurement.

CCD Charge Coupled Device

CUDA™ can refer to a parallel computing platform and programming model of NVIDIA of Santa Clara, Calif., which harnesses the power of the graphics processing unit (GPU).

FOV Field Of View

GSI Global Slide Image

Global Slide Image can refer to an image that a CCD video camera with appropriate optics is capable of acquiring a full slide in one image.

MB Mega Bytes

Site Position of a particular FOV on the slide sample

Slide can refer to a thin flat piece of glass used to hold objects (samples) for examination under a microscope.

Strip can refer to a slice of the camera image near the image border that is used for stitching to the neighboring image.

We claim:

1. A method, comprising:
analyzing, by a machine, a low resolution image of a sample;
determining, by the machine, a scan pattern for the sample based on analysis of the low resolution image of the sample; and
controlling, by the machine, the scan based on the scan pattern, wherein the scan pattern is configured to minimize an amount of back-stitching of scans in the scan pattern.

2. The method of claim 1, wherein the analyzing comprises evaluating a stitching quality attribute by evaluating data near the border of a plurality of sites inside the low resolution image.

3. The method of claim 2, wherein the determining the scan pattern is based on the stitching quality attribute for each of the sites.

4. The method of claim 1, wherein the low resolution image of a sample comprises a low resolution image of an entire slide.

5. The method of claim 2, wherein the analyzing further comprises determining, for each of the plurality of sites, whether a site is stitchable.

6. The method of claim 2, the analyzing further comprises determining, for each of the plurality of sites, a set of at least one direction in which a site is stitchable.

7. A method, comprising:
generating, by a machine, strips corresponding to edges of an image to be stitched with another image to form a composite image;
storing the strips in a strip repository;
moving, by the machine, the image to a full image repository; and
processing tiles from a tiles repository, wherein the tiles include at least one tile obtained from the image.

8. The method of claim 7, further comprising:
removing, by the machine, the image from the memory before a whole slide of which the image is a part has been processed.

9. The method of claim 7, further comprising:
moving the image from a computer memory to a memory of a graphics processing unit after extracting the strips.

10. The method of claim 7, further comprising:
stitching the image to another image; and
removing the image from a buffer after the stitching

11. An apparatus, comprising:
a low resolution analysis section configured to analyze a low resolution image of a sample;
a scan pattern determination section configured to determine a scan pattern for the sample based on analysis of the low resolution image of the sample; and
a controller configured to control the scan based on the scan pattern, wherein the scan pattern is configured to minimize an amount of back-stitching of scans in the scan pattern.

12. The apparatus of claim 10, wherein the low resolution analysis section is configured to evaluate a stitching quality attribute by evaluating data near the border of a plurality of sites inside the low resolution image.

13. The apparatus of claim 12, wherein the scan pattern determination section is configured to determine the scan pattern based on the stitching quality attribute for each of the sites.

14. The apparatus of claim 10, wherein the low resolution image of a sample comprises a low resolution image of an entire slide.

15. The apparatus of claim 12, wherein the low resolution analysis section is configured to determine, for each of the plurality of sites, whether a site is stitchable.

16. The apparatus of claim 12, wherein the low resolution analysis section is configured to determine, for each of the plurality of sites, a set of at least one direction in which a site is stitchable.

17. An apparatus, comprising:
a strip generator configured to generate strips corresponding to edges of an image to be stitched with another image to form a composite image;
a memory manager configured to store the strips in a strip repository and to move the image to a full image repository; and
a processor configured to process tiles from a tiles repository, wherein the tiles include at least one tile obtained from the image.

18. The apparatus of claim 17, wherein the memory manager is further configured to remove the image from the memory before a whole slide of which the image is a part has been processed.

19. The apparatus of claim 17, wherein the memory manager is further configured to move the image from a computer memory to a memory of a graphics processing unit after extracting the strips.

20. The apparatus of claim 17, wherein the processor is further configured to stitch the image to another image and wherein the memory manager is further configured to remove the image from a buffer after the stitching
